(19) United States
(12) Patent Application Publication
(10) Pub. No.: US 2007/0036964 A1
(43) Pub. Date: Feb. 15, 2007

(54) Direct manufacturing using thermoplastic and thermoset

(75) Inventors: Brian T. Rosenberger, Aledo, TX (US); Slade H. Gardner, Fort Worth, TX (US); Craig A. Brice, Keller, TX (US); Stephen R. Wood, Benbrook, TX (US)

Correspondence Address: ROBERT A. McLAUCHLAN, P.O. BOX 26780, AUSTIN, TX, 78755, US

(73) Assignee: Lockheed Martin Corporation

(21) Appl. No.: 11/203,924

(22) Filed: Aug. 15, 2005

(51) Int. Cl. B32B 3/26; B05D 5/10

(52) U.S. Cl. 428/304.4; 427/207.1

(57) ABSTRACT

The present invention provides a direct manufacturing process operable to fabricate three-dimensional physical objects. These three-dimensional physical objects have improved mechanical properties over existing direct manufactured objects. The direct manufacturing process includes an extrusion process, a polymer application process, and a solidification process. The extrusion process deposits a thermoplastic polymer in a series of sequential layers wherein the series of sequential layers are deposited in predetermined patterns. The polymer application process applies compatible polymer(s) after the deposition of each thermoplastic layer. The compatible polymer may be applied in a same or different predetermined pattern when compared to that of the previously deposited thermoplastic layer. The compatible polymer diffuses into voids within the thermoplastic layer. The object is solidified as a series of thermoplastic layers and compatible polymer(s) to produce a three-dimensional physical object that exhibits a combination of the mechanical properties of both the thermoplastic layers and compatible polymers.

### TECHNICAL FIELD OF THE INVENTION

The present invention relates generally to direct manufacturing, and more particularly, a direct manufacturing system that utilizes a combination of thermoplastic and thermoset materials to fabricate three dimensional physical objects having improved mechanical properties.

### BACKGROUND OF THE INVENTION

Direct manufacturing techniques allow three-dimensional articles of a predetermined size and shape to be fabricated. In accordance with conventional techniques, the desired part is initially drawn, either manually or automatically utilizing a computer-aided design (CAD) procedure. Then the part is fabricated using the CAD information within a direct manufacturing system.

Fused deposition modeling (FDM) is one direct manufacturing technique. FDM involves extruding a thermoplastic material in an oven at a temperature where the material is viscous onto a surface mounted on an XY table. Working as a plotter, the model may be drawn one cross-sectional layer at a time until the overall three-dimensional object is complete. The three-dimensional objects may be produced by depositing repeated layers of solidified material until the overall three-dimensional shape is formed. Any material, such as a self-hardening thermoplastic, which adheres to the previous layer at extrusion temperatures and becomes rigid and hard after removal from the deposition oven, may be utilized. Each layer is defined by the previous layer and the thickness is defined by a closely controlled height at which the tip of a dispensing head is positioned above the base or preceding layer and the flow rate of extruded material.

Existing direct manufacturing processes allow three-dimensional objects or parts to be produced using FDM, however, unavoidable voids scattered among the deposition path in any given layer and in between layers can reduce the object's mechanical properties. These voids arise because of incomplete coverage during deposition. There are also regions where good diffusion of the thermoplastic build material to adjacent deposition paths does not exist even though there may be no evident gap between the paths. Voids cause the mechanical properties of the modeled object to be substantially less than that of the material used to fabricate the object. Thus, voids prevent these objects which may be used for modeling purposes from being used under load. The voids between deposition paths and the lack of diffusion between adjacent or successive layers may cause an early failure of the physical object when placed under the load.

Therefore a need exists for an improved method of manufacturing three-dimensional objects wherein the objects have improved mechanical properties and may be used not only for modeling purposes but also under load.

### SUMMARY OF THE INVENTION

The present invention provides a direct manufacturing process using compatible materials such as thermoplastic and thermoset that substantially addresses the above-identified needs as well as other needs. More specifically present invention deposits a combination of both thermoplastic and thermoset materials in a series of sequential layers in order to fabricate three-dimensional physical objects that have improved mechanical properties when compared to conventional direct manufacturing techniques.

The present invention, in one embodiment, provides a direct manufacturing process operable to fabricate three-dimensional physical objects. These three-dimensional physical objects have improved mechanical properties over existing direct manufactured objects. The direct manufacturing process includes an extrusion process, a polymer application process, and a heating or solidification mechanism. The extrusion process deposits a thermoplastic polymer in a series of sequential layers wherein the series of sequential layers are deposited in predetermined patterns. These patterns may be formed from a series of filaments. The polymer application process applies compatible polymer after the deposition of each thermoplastic layer. The compatible polymer may be applied in a same or different predetermined pattern when compared to that of the previously deposited thermoplastic layer. The compatible polymer has features of low viscosity, good wetting and if it is thermoset polymer—a cure temperature in the range of the ambient processing temperature for extrusion of the thermoplastic component. The compatible polymer diffuses into voids and also into the thermoplastic layer. Removal of the object from the deposition oven, or the curing mechanism solidifies the compatible polymer materials. By removing the finished part from the deposition oven the thermoplastic component becomes hard and rigid to produce the three-dimensional physical object that exhibits a combination of the mechanical properties of both the thermoplastic material and compatible polymer.

Another embodiment provides a method with which to fabricate three-dimensional physical objects having improved mechanical properties. This method involves depositing a first pattern layer of thermoplastic material through FDM, extrusion or other like processes. Next, compatible polymers are deposited on the first pattern layer of thermoplastic material. The compatible polymers diffuse into voids within the first pattern layer of thermoplastic material. These processes are repeated by depositing successive patterned layers of thermoplastic and compatible polymers onto the previously-deposited patterned layers. The compatible polymer(s) diffuse into voids not only within a single layer but between pattern layers. Intra-layer voids may be artifacts of layers of the thermoplastic material or within the thermoplastic material. The series of pattern layers of thermoplastic material are solidified with compatible polymers to form three-dimensional objects. These three-dimensional objects have compatible polymer diffused within the voids. The combination of thermoplastic material and compatible polymer(s) allows the fabricated three-dimensional object to have a set of mechanic properties based on a combination of the mechanical properties in the thermoplastic material and compatible polymer(s).

Another embodiment provides a method with which to fabricate three-dimensional physical objects having improved mechanical properties. This method involves depositing layers of thermoplastic material through FDM, extrusion or other like processes to form an entire object. After the entire object is built with thermoplastic polymer, it is removed from the deposition oven. This part is then infused with a compatible polymer using vacuum infusion, capillary wetting, soaking, immersion, resin infusion or similar process. If the infused polymer is a thermoset variety, the infused object is then placed in an oven or autoclave to cure the themoset component. The object can be covered, bagged, sealed, coated or otherwise protected for loss of the infused polymer component during the cure event. The compatible polymer(s) diffuse into voids not only within a single layer but between pattern layers. Intra-layer voids may be artifacts of layers of the thermoplastic material or within the thermoplastic material. The combination of thermoplastic material and compatible polymer(s) allows the fabricated three-dimensional object to have a set of mechanic properties based on a combination of the mechanical properties in the thermoplastic material and compatible polymer(s).

Another embodiment provides a three-dimensional physical object fabricated using fused deposition. This three-dimensional object has improved mechanical properties. The three-dimensional object is built from a series of layers deposited according to predetermined patterns associated with each individual layer. The polymer used for FDM is a formulation of compatible thermoplastic polymer(s) blended with thermoset polymer(s) to create a material system that is capable of a short history of low viscosity behavior at a useful processing temperature, followed by an increase in viscosity due to curing of the thermoset component of the material system. Additional compatible thermoset polymer may be added after each layer is deposited. The thermoset component provides low viscosity material to diffuse into voids and also within the polymer blend layers. The compatible thermoset polymers and thermoplastic material solidify rapidly to form the three-dimensional object. Because both compatible polymers and thermoplastic material are utilized to form the three-dimensional physical object, the mechanical properties of the three-dimensional object comprise a combination of the mechanical properties of both the thermoplastic material and the compatible polymers. The exact properties are determined by the combination. The voids in which the compatible polymers diffuse may be both inter-layer voids and intra-layer voids. Thus the mechanical coupling between individual layers is increased when the compatible polymers are diffused within intra-layer voids.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 provides a functional diagram of a direct manufacturing system in accordance with an embodiment of the present invention;

FIG. 2 depicts a direct manufacturing system in the process of depositing individual layers of a three-dimensional physical object in accordance with an embodiment of the present invention;

FIG. 3A provides an isometric view of a multi-layered three-dimensional object produced using direct manufacturing in accordance with an embodiment of the present invention;

FIG. 3B provides an expanded view of individual layers of a three-dimensional object that can be fabricated using direct manufacturing in accordance with an embodiment of the present invention;

FIG. 4A is a cross-section of thermoplastic filaments used to form individual layers of a three-dimensional object containing intra-filament voids;

FIG. 4B depicts a top-down view of a portion of a layer of the object from FIG. 3B containing intra-layer voids;

FIG. 4C provides a cross-section normal to the thermoplastic filaments of successive layers illustrating the presence of inter-layer and inter-filament voids;

FIG. 5 provides a logic flow diagram describing one method of fabricating a three-dimensional object in accordance with an embodiment of the present invention; and

FIGS. 6A and 6B depict top-down and cross-sectional views of a layered three-dimensional object having compatible polymers diffused within intra-layer and inter-layer voids in accordance with an embodiment of the present invention.

### DETAILED DESCRIPTION OF THE INVENTION

Preferred embodiments of the present invention are illustrated in the FIGUREs, like numerals being used to refer to like and corresponding parts of the various drawings.

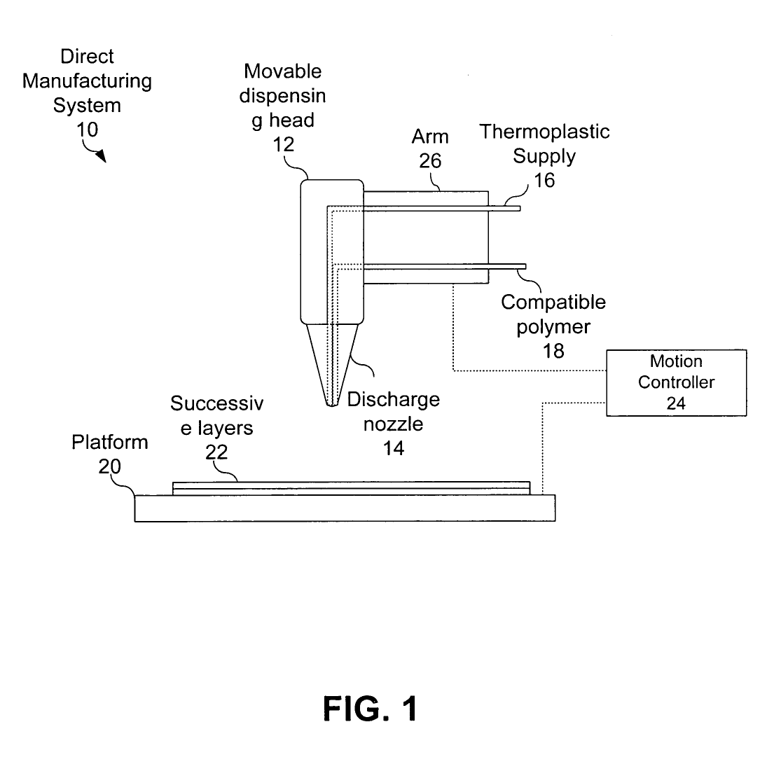

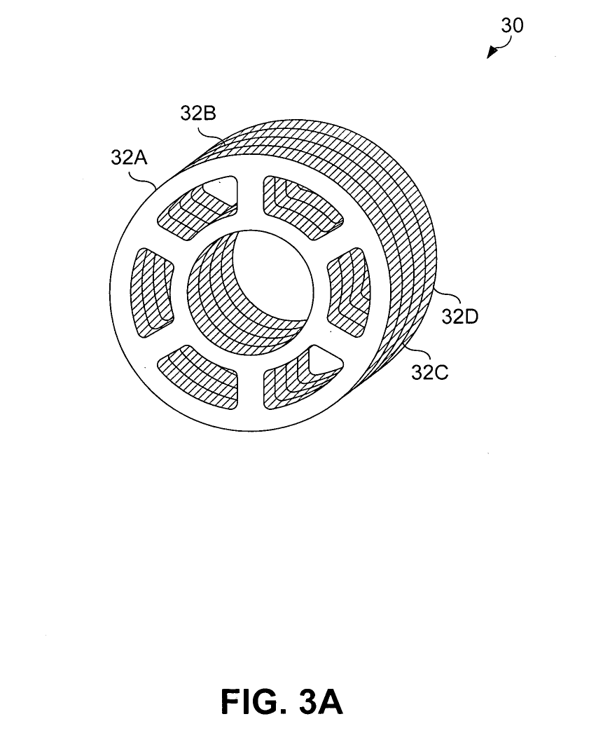

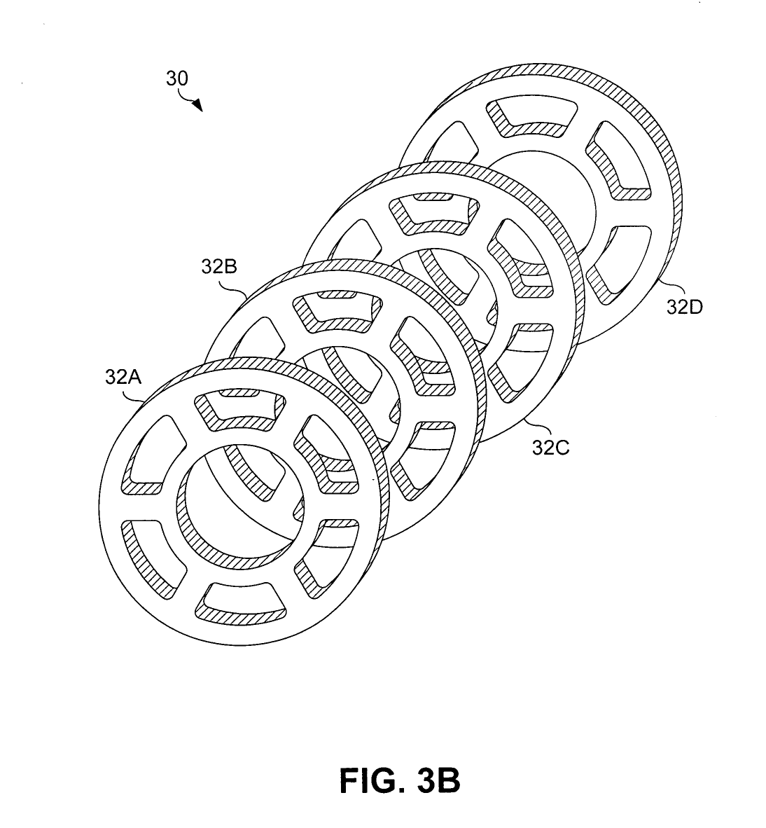

FIG. 1 illustrates one embodiment of the direct manufacturing process provided by the present invention operable to fabricate three-dimensional objects. Direct manufacturing system 10 includes dispensing head 12, discharge nozzle 14, thermoplastic supply 16, compatible polymer supply 18, and platform 20. The three-dimensional physical objects may be formed as a series of successive layers 22 formed on platform 20. Dispensing head 12 and platform 20 are mounted to allow relative motion in three dimensions between dispensing head 12 and platform 20. Motion control 24 may direct the positioning of dispensing head 12, through an arm 26 and/or the positioning of platform 20, in order to achieve the desired relative motion between dispensing head 12 and platform 20. Thermoplastic material and compatible polymers are deposited to form layers 22. Successive layers 22 are laid in predetermine patterns in order to form the desired three-dimensional physical object such as the object illustrated in FIG. 3. Additionally, platform 20 may be heated, cured, irradiated, energized, flooded, evacuated or cooled in order to properly solidify the materials dispensed by discharge nozzle 14 onto platform 20 or previous layers 22.

The compatible polymer from supply 18 diffuses into the intra-layer and inter-layer voids and diffuses into the thermoplastic polymer. The compatible polymer solidifies in these voids and provides adhesion and consolidation. This improves the bonding between filaments of the thermoplastic material deposited within a layer and between filaments within adjacent layers resulting in improved mechanical properties of the three-dimensional object.

The compatible polymer may be applied or extruded after the deposition of each thermoplastic layer. The compatible polymer may be applied in the same predetermined pattern of the most recently deposited thermoplastic layer or a different pattern optimized to address the voids associated with that deposited thermoplastic polymer layer. The combination of thermoplastic layers and diffused compatible polymers may be solidified by curing or other like process known to those having skill in the art. Additionally, in order to aid in the diffusion process a vacuum process may be applied to draw compatible polymers into the voids.

This combination of materials allow individual layers as well as the entire three-dimensional object to have improved mechanical properties that are a combination of both the compatible polymer(s)' mechanical properties and the mechanical properties of the thermoplastic. For example, if the compatible polymer is a thermoset material, the properties of hardness, stiffness, low creep, and solvent resistance may be imparted in part to the three-dimensional physical object. Similarly, mechanical properties of the thermoplastic material such as ductility, toughness and high energy to failure may also be part of the overall properties of the three-dimensional object. This allows direct manufactured objects to be used for modeling, as well as under actual load conditions.

Dispensing head 12 as shown has a discharge nozzle 14 that is operably coupled to a thermoplastic supply or reservoir, as well as a supply of compatible polymer 18. Movable dispensing head 12 receives and dispenses both the thermoplastic material and the compatible polymer through a discharge orifice within the discharge nozzle in close proximity to platform 20 in accordance with or as directed by motion controller 24. Although motion controller 24 is identified as a motion controller, it may also be operable to meter and control the dispensing of both the thermoplastic and/or compatible polymer to be deposited in order to form the individual layers of the three-dimensional object.

Motion control system 24 provides mechanical means for translation of relative movement between the platform 20 and dispensing head 12. In one embodiment, platform 20 may move in an X and Y direction while dispensing head 12 is operable to move along the Z axis. However, other embodiments may reposition either or both dispensing head 12 or platform 20 along the X, Y, and Z axis.

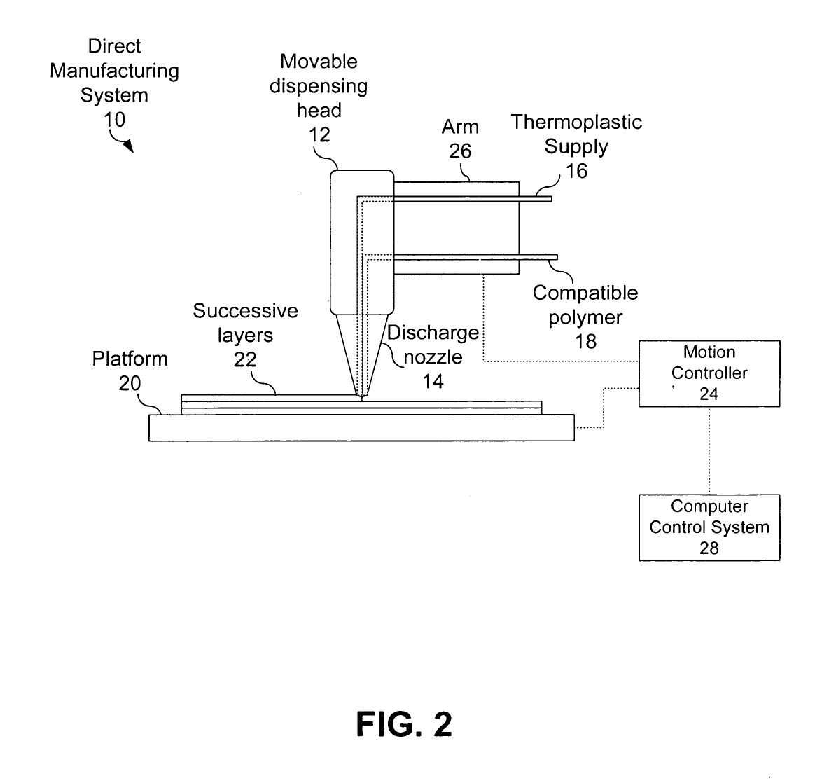

For automated operation, a computer control system 28, as shown in FIG. 2, may direct motion control 24. FIG. 2 shows dispensing head 12 in close proximity to platform 20 and in the process of depositing individual filaments of thermoplastic material to form the upper layer of successive layers 22.

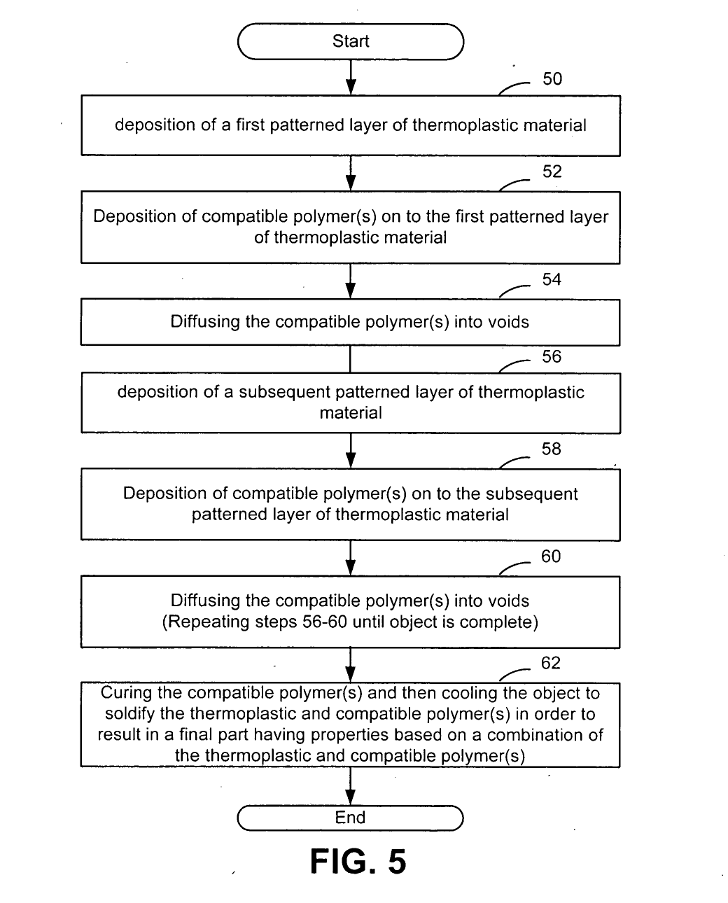

Computer control system 28 may receive inputs from a computer-aided design (CAD) modeling system operable to breakdown a physical object into a series of patterned layers. The Computer control system and motion controller may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The Computer control system executes, operational instructions corresponding to at least some of the steps and/or functions illustrated in FIG. 5.

Relative motion between dispensing head 12 and platform 20 dispenses thermoplastic, or other like material, and compatible polymers to form successive layers 22. The series of successive layers form the three-dimensional physical object. Computer control system 28 may receive the design of the three-dimensional physical object utilizing available CAD software or other like software. A software program divides the object into multiple layers to provide multiple layer data corresponding to the particular shape of each separate layer to the motion controller. The motion controller then directs the relative motion between dispensing head 12 and platform 20 can trace the individual layers.

FIG. 3A provides an isometric view of a three-dimensional object that has been detached from platform 20. Three-dimensional physical object 30 may comprise a series of successive layers. Here, layers 32A, 32B, 32C and 32D make up physical object 30. FIG. 3B provides an expanded view of successive layers 32A, 32B, 32C and 32D that comprise physical object 30. Voids within the individual layers may affect the strength associated with physical structure 30. The individual layers may be deposited as a strand or strands of thermoplastic or other like materials. Strand 34 may have voids within it. Also, the interface between strands may also contain voids. Although these FIGs. Show only four layers, it should be understood that the object may include numerous individual layers.

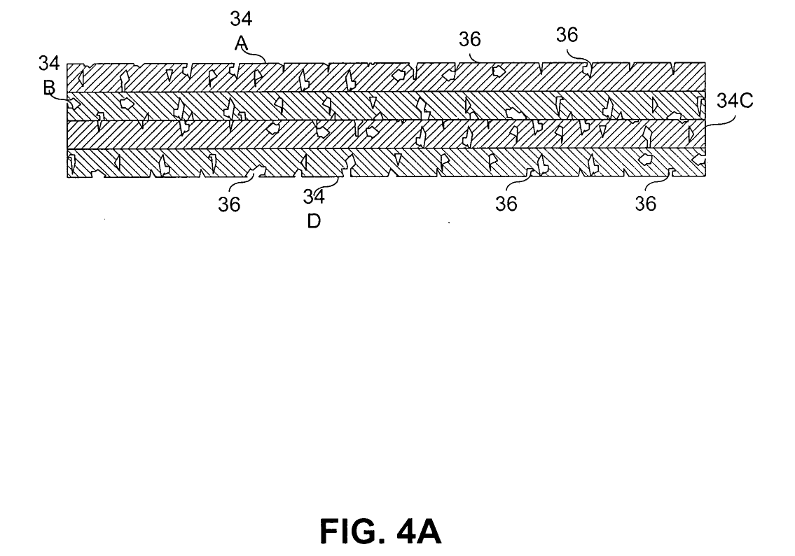

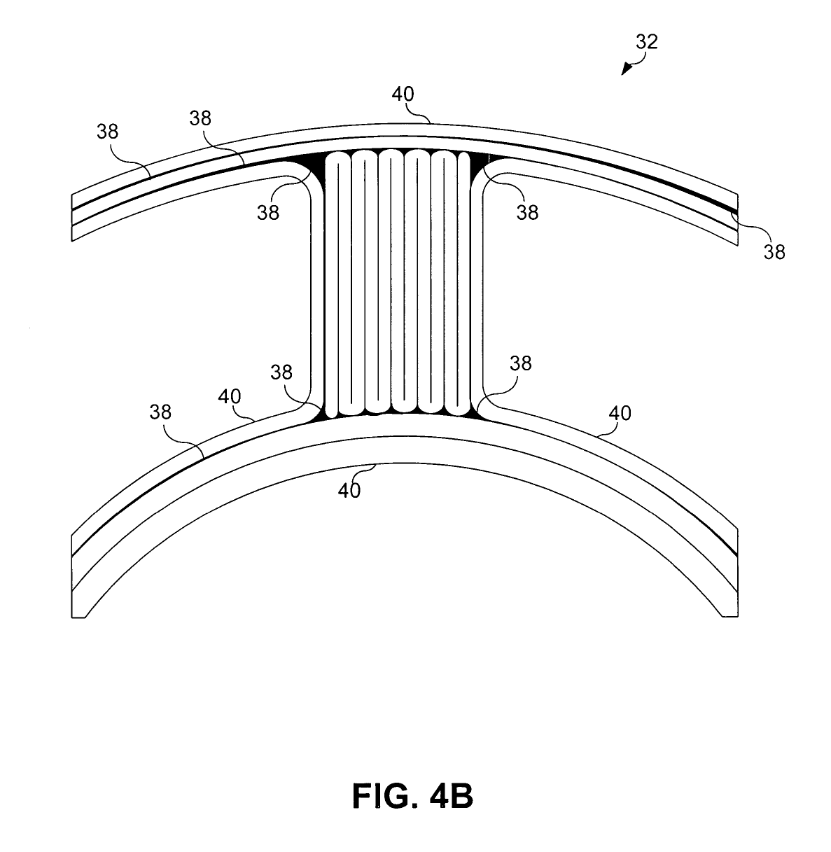

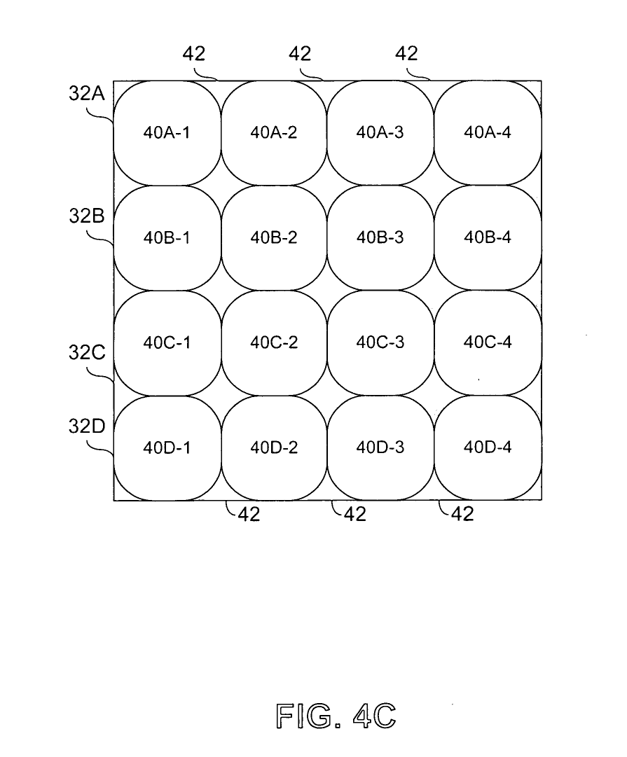

FIG. 4A shows a cross-section of a physical object wherein strands 34A, 34B, 34C and 34D are stacked on top of one another and may contain intra-filament voids within the thermoplastic. The bond quality of individual filaments both within individual or multiple layers determines the integrity and mechanical property of the resultant three-dimensional physical object. FIGS. 4A, 4B and 4C illustrate three types of voids that may affect the mechanical properties of the resultant physical object. FIG. 4A illustrates that individual filaments used to form a three-dimensional object such as filaments 34A, 34B, 34C and 34D may contain voids 36 within an individual filament. These voids may greatly reduce the mechanical properties of the three-dimensional object. Additionally, FIG. 4B provides a top-down view of the upper portion of one of the layers 32 of physical object 30. Because this single layer may be laid out as a series of filaments 40 of thermoplastic material intra-layer voids 38 may occur within layer 32 due to how filaments 40 are laid out (patterned) to create and form layer 32. FIG. 4C is a cross-section through several layers normal to a series of filaments. Here, inter-layer voids 42 in between filaments 40 that are contained within successive layers 32A, 32B, 32C and 32D may reduce the mechanical properties of the object. FIG. 4C depicts inter-layer voids that again may affect the overall mechanical properties of the resultant three-dimensional object.

Three-dimensional objects produced using conventional teachings may be made by extruding filaments in a prescribed pattern onto a platform or previous layer. As the material deposited solidifies, the material bonds with the surrounding material. The formation of the bond or partial bonding between the filaments results in the voids of FIGS. 4A, 4B and 4C. The overall properties of the three-dimensional model are determined by the properties of individual layers and the bond between layers. Unfortunately, the strength of the bond between filaments within a single layer or between layers is not the same as that of the individual filament or material used to produce a filament. Rather, the mechanical properties are determined by the void density of intra-filament, intra-layer and inter-layer voids. The present invention, in addition to applying or extruding a thermoplastic material or other like material as filaments, to form the individual layers, deposits a compatible polymer, such as a thermoset polymer or reactive oligomer. Examples of such material combinations are thermoplastics of Ultem polyetherimide and thermoset polymers or reactive oligomers including Phenyl Ethynyl terminated oligomers of Ultem-type chemistry. The compatible polymer is deposited on top of an individual layer and diffuses into the intra-filament, intra-layer and inter-layer bonds within the object. Thus, providing an object where mechanical properties are improved by reducing or eliminating the presence of voids.

FIG. 5 provides a logic flow diagram illustrating one method operable to fabricate three-dimensional physical objects having improved mechanical properties. This process begins at step 50 where a first patterned layer of thermoplastic material is deposited. Then, step 52 deposits on top of this first patterned layer compatible polymer(s). In step 54, the compatible polymers diffuse into voids that may be within individual filaments of extruded thermoplastic material or in between individual filaments. In step 56, a second or successive patterned layer of thermoplastic material is deposited onto the original or other prior patterned layer that comprises thermoplastic material with diffused compatible polymers. In step 58, compatible polymers are deposited onto this successive layer, which then diffuse in step 60 into voids wherein this time the voids may include not only intrafilament and intra-layer voids, but also inter-layer voids. Steps 56, 58 and 60 are repeated until the entire object is built up from successive patterned layer depositions. These patterned layers of thermoplastic material and compatible polymers then solidify in step 62 wherein the solidified three-dimensional object will exhibit mechanical properties that are a combination of the mechanical properties of both the thermoplastic material and compatible polymers. This solidification process may involve the application of heat, pressure, irradiation, flood gas, or energy field to cure the material or a reduction in temperature in order to solidify the material. A further step may be included or associated with the diffusion of the compatible polymers into voids wherein a vacuum is applied in order to better draw the compatible polymers into the voids.

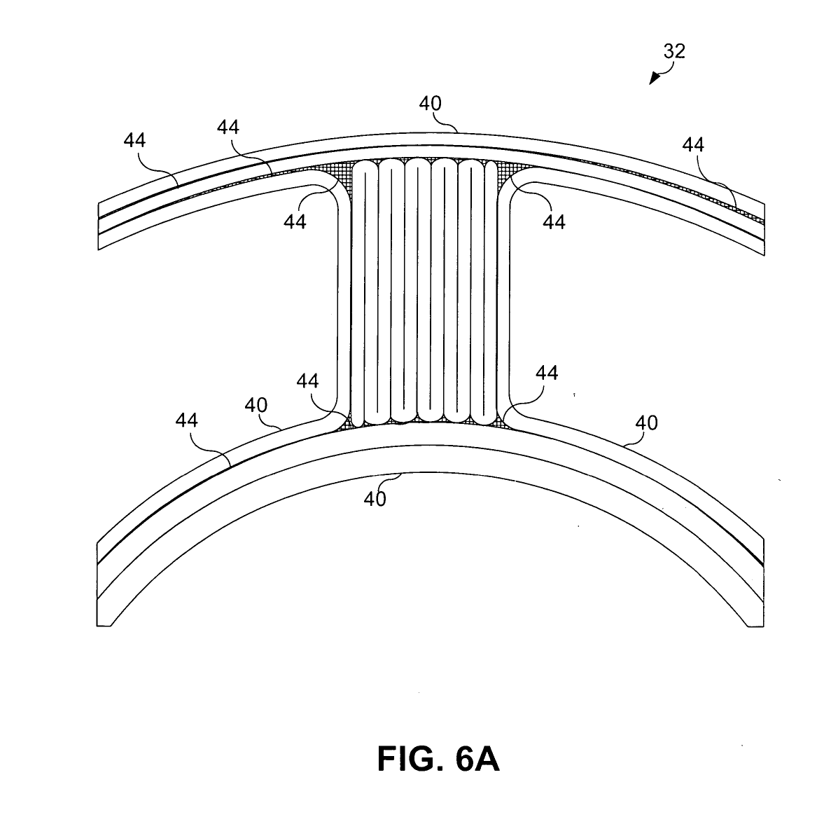

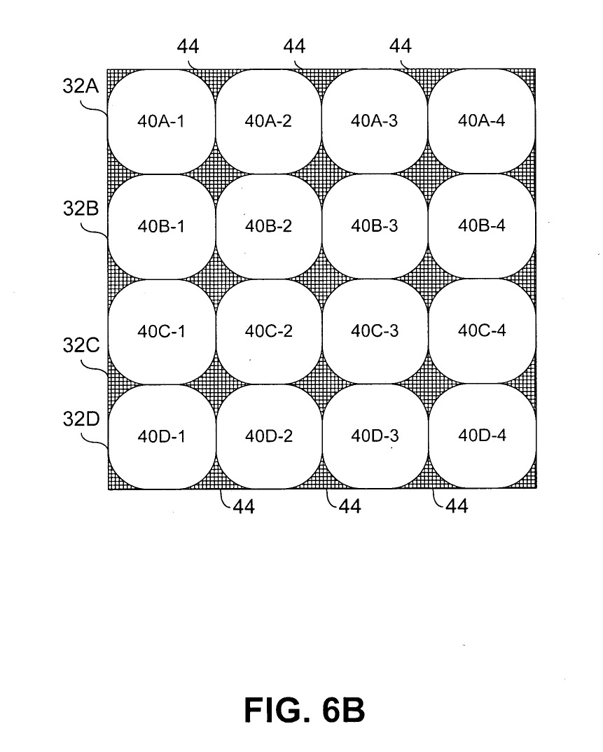

FIGS. 6A and 6B are similar to FIGS. 4B and 4C, however, in place of the voids 36, compatible polymers diffused into the intra-layer voids of FIG. 4B and the inter-layer voids of FIG. 4C. This allows a three-dimensional physical object, such as the physical object of FIG. 3A, to be fabricated from successive layers of thermoplastic material having compatible polymers diffused therein in areas 44. This results in a three-dimensional physical object whose mechanical properties comprise an improved combination of the mechanical properties of both the thermoplastic material and the compatible polymers.

In summary, the present invention provides a direct manufacturing process operable to fabricate three-dimensional physical objects. These three-dimensional physical objects have improved mechanical properties over existing direct manufactured objects. The direct manufacturing process includes an extrusion process, a polymer application process, and a solidifying mechanism. The extrusion process deposits a thermoplastic polymer in a series of sequential layers wherein the series of sequential layers are deposited in predetermined patterns. The polymer application process applies compatible polymer(s) after the deposition of each thermoplastic layer or after all thermoplastic layers. The compatible polymer may be applied in a same or different predetermined pattern when compared to that of the previously deposited thermoplastic layer. The compatible polymer(s) diffuse into voids within the thermoplastic layer. A solidification process cures or otherwise solidifies the thermoplastic layers and compatible polymer(s) to produce the three-dimensional physical object that exhibits a combination of the mechanical properties of both the thermoplastic sequential layer and the fused compatible polymers.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions and alterations can be made hereto without departing from the spirit and scope of the invention as described by the appended claims.

What is claimed is:

1. A direct manufacturing process operable to fabricate three-dimensional physical objects having improved mechanical properties, comprising:
a deposition process operable to deposit a thermoplastic material in a series of sequential layers, wherein the series of sequential layers are deposited in a predetermined pattern;
a polymer application process operable to apply compatible polymer(s) after the deposition of each thermoplastic layer, wherein the compatible polymer is applied in the predetermined pattern of the deposited thermoplastic layer, and wherein the compatible polymer diffuses into voids within the thermoplastic layer; and
a solidification mechanism operable to solidify the combination of thermoplastic sequential layers and diffused compatible polymers.

2. The direct manufacturing process of claim 1, wherein the voids comprise:
intra-filament voids;
inter-layer voids; and
intra-layer voids.

3. The direct manufacturing process of claim 1, wherein the compatible polymer comprises a thermoset polymer or reactive oligomer.

4. The direct manufacturing process of claim 1, wherein:
the thermoplastic comprises Ultem Polyetherimide; and
the compatible polymer comprises Phenyl Ethynyl terminated oligomers of Ultem-type chemistry.

5. The direct manufacturing process of claim 1, wherein:
the improved mechanical properties comprise a combination of thermoset mechanical properties and thermoplastic mechanical properties.

6. The direct manufacturing process of claim 5, wherein:
the thermoset mechanical properties comprise at least one property selected from the group consisting of:
hardness;
stiffness;
low creep; and
solvent resistance; and
the thermoplastic mechanical properties comprise at least one property selected from the group consisting of:
ductility;
toughness; and
high energy to failure.

7. The direct manufacturing process of claim 1, further comprising a vacuum process operable to draw compatible polymers into the voids.

8. The direct manufacturing process of claim 1, wherein the deposition process further comprises:
a reservoir of thermoplastic material;
a base member;
a dispensing system operably coupled to the reservoir, wherein the dispensing system:
receives the thermoplastic material; and
dispenses the thermoplastic material through a discharge orifice in close proximity to the base member; and
a controller operable to control:
the relative position of the discharge orifice to the base member in three dimensions according to the predetermined pattern of a first sequential layer; and
the relative position of the discharge orifice to deposited sequential layers in three dimensions according to the predetermined pattern of a successive sequential layer to be deposited.

9. The direct manufacturing process of claim 8, wherein the controller displaces the discharge orifice a predetermined incremental distance relative to the base member and thence relative to each successive sequential layer deposited prior to the commencement of the formation of each successive sequential layer in order to form the series of sequential layers of thermoplastic material and compatible polymer(s) having a predetermined thickness.

10. The direct manufacturing process of claim 1, wherein the thermoplastic material solidifies after deposition.

11. A method operable to fabricate three-dimensional physical objects having improved mechanical properties, comprising:
depositing a first patterned layer of thermoplastic material;
depositing compatible polymer(s) on the first patterned layer of thermoplastic material;
diffusing the compatible polymer(s) into voids within the first patterned layer of thermoplastic material;
depositing successive patterned layer(s) of thermoplastic material onto previously deposited patterned layer(s) of thermoplastic material;
depositing the compatible polymer on the successive patterned layer(s) of thermoplastic material;
diffusing the compatible polymer into voids within the successive patterned layer(s) of thermoplastic material; and
solidifying the patterned layers of thermoplastic material and compatible polymers to form the three-dimensional physical object.

12. The method of claim 11, wherein solidifying comprises applying heat, radiation, electric field, magnetic field, pressure or flood gas to cure the thermoplastic material and compatible polymer.

13. The method of claim 11, wherein the voids comprise:
inter-filament voids;
inter-layer voids; and
intra-layer voids.

14. The method of claim 11, wherein the compatible polymer comprises a thermoset polymer or reactive oligomer.

15. The method of claim 11, wherein:
the thermoplastic polymer comprises Ultem Polyetherimide; and
the compatible polymer comprises Phenyl Ethynyl terminated oligomers of Ultem-type chemistry.

16. The method of claim 11, wherein the improved mechanical properties comprise a combination of compatible polymer mechanical properties and thermoplastic mechanical properties.

17. The method of claim 16, wherein:
the thermoset mechanical properties comprise at least one property selected from the group consisting of:
hardness;
stiffness;
low creep; and
solvent resistance; and
the thermoplastic mechanical properties comprise at least one property selected from the group consisting of:
ductility;
toughness; and
high energy to failure.

18. The method of claim 11, further comprising applying a vacuum operable to draw compatible polymer(s) into the voids.

19. The method of claim 11, wherein depositing the thermoplastic material comprises an extrusion process.

20. The method of claim 11, wherein a controller adjusts the pattern of the deposited thermoplastic material layers and compatible polymers to fabricate the three-dimensional object as a series of layers.

21. A three-dimensional physical object fabricated using fused deposition, wherein the three-dimensional physical object has improved mechanical properties, comprising:
a first layer of thermoplastic material deposited according to a predetermined pattern associated with the first layer;
a series of successive thermoplastic material layers deposited according to a predetermined pattern associated with each layer; and
compatible polymer(s) diffused into voids within the thermoplastic material layers, wherein the compatible polymers and thermoplastic polymers solidify to form the three-dimensional physical object, and wherein the mechanical properties of the three-dimensional physical object comprise a combination of mechanical properties of the thermoplastic material and compatible polymer(s).

22. The three-dimensional physical object of claim 21, wherein the voids comprise:
inter-filament voids;
inter-layer voids; and
intra-layer voids.

23. The three-dimensional physical object of claim 21, wherein the compatible polymers and thermoplastic polymers solidify through the application of heat, radiation, pressure, electric field, magnetic field or presence of flood gas.

24. The three-dimensional physical object of claim 21, wherein the compatible polymers and thermoplastic polymers solidify through the application of cooling.
